(19) United States
(12) Patent Application Publication
(10) Pub. No.: US 2016/0246502 A1
(43) Pub. Date: Aug. 25, 2016

(54) VIRTUAL MEMORY SYSTEM BASED ON THE STORAGE DEVICE TO SUPPORT LARGE OUTPUT

(71) Applicant: INDUSTRY ACADEMIC COOPERATION FOUNDATION OF YEUNGNAM UNIVERSITY, Gyeongsangbuk-do (KR)

(72) Inventor: Gyu Sang CHOI, Suseong-gu (KR)

(21) Appl. No.: 14/802,560

(22) Filed: Jul. 17, 2015

(30) Foreign Application Priority Data
Feb. 25, 2015 (KR) 10-2015-0026656

(51) Int. Cl. G06F 3/06; G06F 9/44

(52) U.S. Cl. CPC G06F 3/061; G06F 3/0604; G06F 3/0655; G06F 3/0685; G06F 3/0632; G06F 9/4401

(57) ABSTRACT

The following description relates to a virtual memory system, and a virtual memory system based on a storage device supporting massive storage input/output with improved system feature by corresponding a page size, i.e., an elementary unit of a virtual memory with a read/write unit of a storage device that supports massive storage input/output (I/O). The virtual memory system based on a storage device supporting massive input/output based on an NAND flash memory includes a main memory; a storage device configured to read/write data with a certain page unit; a virtual memory that corresponds with the main memory and read/write data that is determined with a page unit size different from the storage device; and a controller configured to recognize read/write unit of the storage device and the virtual memory and control the respective units to correspond with each other and, wherein the controller is configured to correspond between the data read/write unit of the virtual memory and a data unit of the storage device. The virtual memory performs read/write operation of data based on a page unit of the storage device that is corresponding by the controller. The virtual memory read/write a data based on a multiple a page unit of the storage device.

### CROSS-REFERENCE TO RELATED APPLICATIONS

This application claims priority from Korean Patent Application No. 10-2015-0026656, filed on Feb. 25, 2015 in the Korean Intellectual Property Office, the disclosure of which is incorporated herein by reference in its entirety.

### BACKGROUND

1. Field

The following description relates to a virtual memory system, and a virtual memory system based on a storage device supporting massive storage input/output with improved system feature by corresponding a page size, i.e., an elementary unit of a virtual memory with a read/write unit of a storage device that supports massive storage input/output (I/O).

Recently storage devices supporting massive storage input/output such as a NAND flash memory has various advantages comparing to a HDD (Hard disk drive) of a related art hence, many are used in a computer system.

Especially, a storage device based on the NAND flash memory has various advantages such as good feature, low energy consumption, high credibility, small form factor and etc. compared to the HDD of a related art, hence much used in a computer system.

Market size of a SSD (Solid State drive) storage device is expected to grow rapidly every year. However, the market share of the NAND flash memory is known to be much smaller than that of the HDD.

Accordingly, the unit cost of the NAND flash memory is higher than the HDD of a related art. The NAND flash memory has disadvantages in that having similar features compared to the HDD in certain works such as a random write.

In other words, HDD performs read/write operation based on a sector of 51 2 bytes. However, the NAND flash memory performs read/write operation with a page unit of 2 Kbytes or 4 Kbytes that is bigger than the HDD. Additionally, recent NAND flash memory may perform read/write supporting a 8 Kbytes size page.

2. Description of Related Art

Meanwhile, the virtual memory system is managed with a page unit of certain size.

A virtual memory system of many operating system manages a main memory dividing in a page of 4 Kbytes.

Likewise, a virtual memory system performs read/write operated based on a unit that is bigger compared to the HDD hence, does not correspond with a virtual memory system formed with a page of 4 Kbytes.

Accordingly, in the afore-mentioned virtual memory system of a related art, a mismatch between a page of a virtual memory system of an operating system and a page of an NAND flash memory may be generated. If mismatch between a virtual memory system page of an operating system and an NAND flash memory page is generated, performance may be degraded.

### SUMMARY

The following description relates to a virtual memory system based on a storage device supporting massive storage input/output with improved system, in an effort to solve mismatch between a page size of a virtual memory system of a related art and an elementary unit of a read/write operation of a storage device. Accordingly, the following description provides a virtual memory system with a page size that is an elementary unit of a virtual memory corresponding with an elementary unit of read/write of a storage device supporting massive storage input/output.

An embodiment of the present description provides a virtual memory system based on a storage device supporting massive input/output including a main memory; a storage device configured to read/write data based on a certain page unit; a virtual memory that corresponds with the main memory and determined with a page unit size different from the storage device and read/write data; and a controller configured to recognize read/write unit of the storage device and the virtual memory and control the respective units to correspond with each other.

The controller is configured to correspond between the data read/write unit of the virtual memory and a data unit of the storage device. Additionally, the virtual memory performs read/write operation of data based on a page unit of the storage device that is corresponding by the controller.

Further, the controller determines the data read/write unit of the virtual memory as a multiple of a page unit of the storage device. The virtual memory read/write a data with a multiple a page unit of the storage device that is determined by the controller.

The storage device may be placed in a SWAP area.

The storage device may perform ‘SWAP IN’ or ‘SWAP OUT’ with an active page unit during data transfer between the main memory and the SWAP area.

A virtual memory system based on a storage device supporting massive input/output according to an embodiment of the present description provides a page size that is an elementary unit of a virtual memory corresponding with an elementary unit of a read/write of a storage device. Thereby, provides system improvement in storage devices based on massive input/output such as a NAND flash memory with bigger elementary unit of read/write compared to a HDD.

### BRIEF DESCRIPTION OF THE DRAWING

FIG. 1 is a block diagram illustrating a virtual memory system based on a storage device supporting massive input/output according to an embodiment of the present description.

FIG. 2 to FIG. 4 are block diagrams of a memory according to an embodiment of the present description illustrating data transfer process among a main memory, a virtual memory, a page table and a storage device.

### DETAILED DESCRIPTION OF THE PREFERRED EMBODIMENT

Certain exemplary embodiments of the present inventive concept will now be described in greater detail with reference to the accompanying drawings. In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

Hereinafter relates to an embodiment of the present description referring to the drawing.

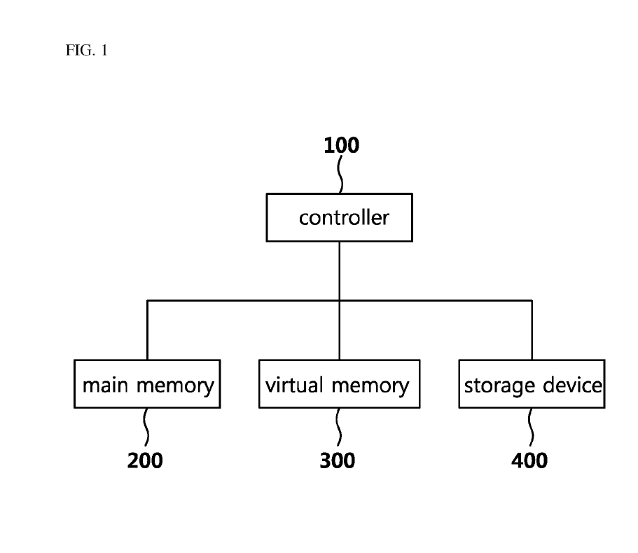

FIG. 1 is a block diagram illustrating a virtual memory system based on a storage device supporting massive input/output according to an embodiment of the present description.

As shown in FIG. 1, a virtual memory system based on a storage device supporting massive input/output according to an embodiment of the present description includes a controller 100, a main memory 200, a virtual memory 300, a storage device (HDD) 400 and a page table 500.

A virtual memory and a physical memory of an operating system according to an embodiment of the present description are managed with a page unit of a certain identical size. Further, the virtual memory system of many operating systems is managed with a main memory that is divided into a page of 4 Kbytes. Moreover, a HDD performs read/write with 512 bytes sector unit. However, a NAND flash memory that is one of massive input/output storage devices only performs read/write with the page unit of 2 Kbytes or 4 Kbytes which is bigger than the HDD. Additionally, recent NAND flash memory supports a page size of 8 Kbytes and performs read/write. Massive capacity in a storage device supporting massive input/output according to an embodiment of the present description refers to input/output capacity of about over 8 Kbytes.

The virtual memory system of the operating system comprises and manages with a bigger size than a physical memory (DRAM) of related art. The virtual memory that exceed in an actual physical memory (DRAM) is a SWAP memory and stored in an actual storage device 400 and if necessary may be ‘SWAP OUT’ to a main memory 200. Further, a page that is not needed in the main memory 200 performs ‘SWAP IN’ to a SWAP memory of a storage device 400. Likewise, page movement between the SWAP memory and the virtual memory is performed often and in this case read/write unit may become the page size of the virtual memory.

However, in this case, there may be a mismatch between the page size of the virtual memory system of the operating system and the page size of the NAND flash memory and may generate function degradation. Especially, when the page size of the virtual memory is smaller than the page unit of the NAND flash memory, there may be a higher possibility that at least more than one page of the NAND flash memory performs read/write when performing read/write of at least one page of the virtual memory. Further, in this case, further bigger data may be accessed than a required data. Accordingly, performance of the system may be degraded.

Accordingly, the present description determines the page size that is the elementary unit of the virtual memory to correspond with the elementary unit of a read/write of a storage device supporting massive input/output. In other words, when booting a system, elementary read/write unit of a storage device is recognized and the page size of the virtual memory actively corresponding to the unit size.

For this, the present description includes a main memory 200, a storage device 400 configured to read/write a data with a certain page unit, and a virtual memory 300 that correspond to the main memory 200 and read/write data that is determined with a bigger page unit than the storage device 400 and a controller 100 configured to recognize read/write unit of the storage device 400 and the virtual memory 300 and controls for corresponding the units therebetween. The page table 500 stores the data of the certain page data in a table form and manages according to units.

The controller 100 is a device controlling the entire system. The controller 100 process the material received from various input devices then control the process of sending the result to an output device. The afore-mentioned controller may be applied to a CPU (central processing unit) or a microprocessor. Herein, the CPU includes an ALU (arithmetic logic unit) that performs comparison, determination and calculation and a control unit that performs interpretation of an instruction and processing thereof. The ALU includes an adder configured to perform various additions and an accumulator configured to temporarily remember a result of a calculation and a logical operation, and a register that is a temporary memory placed in the CPU.

The main memory 200 is ‘the main memory unit’ that is a memory calling currently processing data of a computer within. Further the main memory includes a semiconductor device and performs a random access method with fast processing. The main memory is a device used when the CPU and various devices use the main memory when taking out the temporarily stored data to use. The main memory is a volatile memory with the memory erases when power is blocked. The main memory may be divided into ROM (read only memory) and RAM (random access memory) as well known. ROM is a read only memory, i.e., a non-volatile memory with information not erased although the computer power is blocked. On the other hand, the RAM is a temporary storage place of data required by the CPU and an instruction system and can perform read/write. RAM is a volatile memory of stored data erased when power is blocked.

The main memory 200 according to an embodiment of the present description may include a NAND flash memory based on a massive input/output of about over 8 Kbytes. Herein, the flash memory is a memory with data not erased although power is blocked, i.e., a next-generation semiconductor device that is required for minimization of PC. The flash memory is not only a non-volatile memory chip with input information not erased although power is off based on a standard that is made by a consultation of PC memory card standardization agency such as a PC Memory Card International Association (PCMCIA), Japanese Electronics Industry Development Association (JEIDDA) and etc. but also may input data freely. In other words, the flash memory has advantages of ROM preserving stored data although power is blocked and of RAM that freely input/output information.

The virtual memory 300 moves an unused program to a special area in a back-up memory and use the back-up memory as a main memory when an amount of a program of a main memory is big. The part of the back-up memory used herein is called a virtual memory. When processing program group becomes big, the main memory may not accommodate the entire processing program group. Herein, a special area is formed in the back-up memory and remembers the program group and uses this area as a main memory. This method enables performance of a program regardless of a physical capacity of a main memory.

The storage device 400 may also refer to a back-up memory or an external memory and a memory to store a program or a data outside of a computer CPU. A speed of the storage device 400 is slower than the main memory but can permanently preserve materials. The storage device 400 is formed outside of the computer CPU and used to back-up limited memory capacity of the main memory and the memory is not erased even though the power is blocked. The processing speed of the main memory comprised of a semiconductor is fast but stored material will be erased when power is blocked and permanently preserving massive material may be difficult because the cost is relatively more expensive than that of the back-up memory. Contrariwise, the back-up memory has an advantage in that although the processing speed is relatively slower than the main memory, massive data may be permanently stored since the cost is cheap.

The storage device of the following description may include a hard disk (HDD). The HDD is a back-up memory configured to store data that is to permanently store program or data in a disc aluminum substrate coated with a magnetic substance. A back-up memory according to an embodiment of the present disclosure includes device that use a magneto such as a magnetic tape and a magnetic disk, using light like a laser disk and using both like a magneto-optical disk. Floppy disk, hard disk, CD-ROM and etc. are back-up memory that are used a lot in a PC.

The controller 100 of a present description may perform active correspondence or real-time correspondence between the read/write unit of the virtual memory 300 and the data unit of the storage device 400 when booting the system. The virtual memory 300 may read/write data with a page unit of the storage device 400 corresponding by the controller 100.

However, when the page size of the virtual memory 300 of an operating system does not correspond with the elementary read/write size of a recognized storage device, the page size of the virtual memory 300 of the operating system may not be determined with a multiple of elementary read/write size.

Accordingly, When booting the system, the controller 100 determines a data read/write unit of the virtual memory 300 as a multiple of a page unit of the storage device 400. Further, the virtual memory 300 performs read/write of a data with a multiple of the storage device 400 page unit that is determined by the controller 100. A multiple of the page unit may be determined with multiples of 2, 3, 4 and etc. and may be determined with an even or odd number multiple.

Further, the storage device 400 includes a SWAP area and the storage device 400 performs SWAP IN or SWAP OUT with an active page unit during movement between the main memory 300 and the SWAP area.

Accordingly, a virtual memory area that exceeds in a physical memory is stored in an actual storage device 400 as a SWAP memory thereby, SWAP OUT to a main memory 200 if needed. A page not needed in the main memory 200 performs ‘SWAP IN’ to a SWAP memory of a storage device 400. The page size of a virtual memory system of the operating system corresponds with a page size of a NAND flash memory or determined as a multiple thus, prevent performance degradation that may be caused due to unit mismatch. Especially, by only accessing data that is required to read/write a page of a virtual memory 300 and a NAND flash memory page, performance degradation of a system can be prevented.

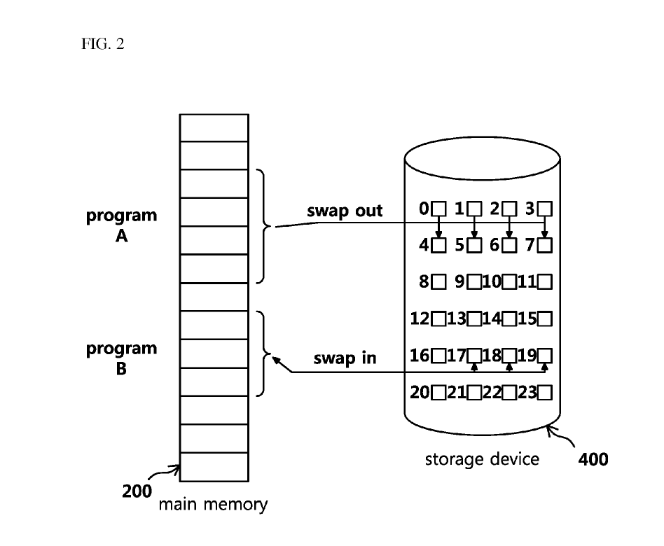

FIG. 2 to FIG. 4 are block diagrams of a memory according to an embodiment of the present description illustrating data transfer process among a main memory, a virtual memory, a page table and a storage device. Hereinafter illustrates an embodiment of the present description referring to FIG. 2 to FIG. 4.

First, as illustrated in FIG. 2, four pages used in a program A is sent to a SWAP area of the storage device 400 and three pages used in a program B performs read to the main memory 200.

More input/output of a storage device may be performed when a page size of the memory 200 and input/output (I/O) unit of the storage device 400 does not correspond.

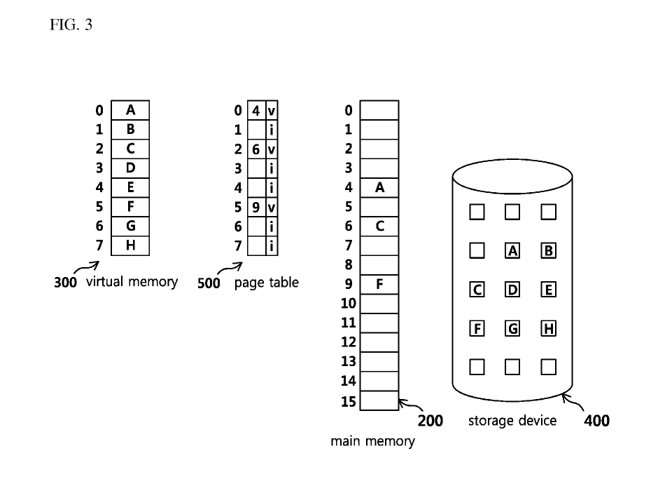

A page table 500 of FIG. 3 illustrates a certain page included in the main memory 200 of a virtual memory 300 page and a different page included in the storage device 400.

Accordingly, ‘V’ refers to ‘valid’ and shows that a related page is included in a main memory 200. Further, ‘I’ refers to ‘invalid,’ showing that a related page is included in the storage device 400.

Thus, a virtual memory 300 comprises 8 pages in FIG. 3. Among the 8 pages, page number 0, 2, and 5 are included in the main memory 200 and other pages are included in the storage device 400.

Basically, the 8 pages of the virtual memory 300 is included in the storage device 400 initially and loaded in the main memory 200 when needed.

Thus, the main memory 200 includes A, C, and F and other B, D, E, G, and H are included in the storage device 400.

Likewise, when the storage device 400 read data with the main memory 200, a date performs read with a page unit and input/output (I/O) herein is performed. A number of input/output may differ according to whether a page corresponds with an input/output unit of the storage device 400.

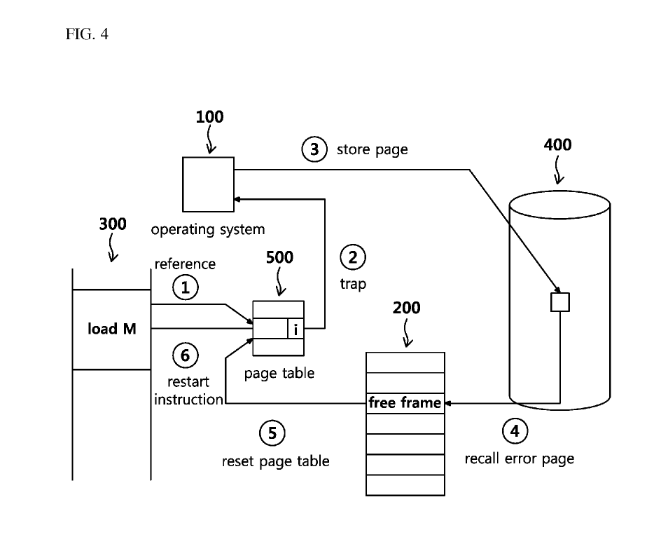

In FIG. 4, step 1 access a special memory address when performing a certain instruction and first access a page table 500 with information regarding a page including the address.

Step 2 generates a TRAP when the page is not included in the main memory 200 that is referred as a page fault. When the page is included in the main memory 200, it is not a page fault so a CPU, i.e., a controller 100, may access the page.

In step 3, an operating system finds a free page in an original main memory 200 to load a page without the main memory 200 to a disk, i.e., to load from the storage device 400 to the main memory 200.

In step 4, a data in a storage device 400 is sent to the free page that is found in the afore-mentioned step 3.

In step 5, when step 4 is completed, a page table 500 is updated. In other words, an information of the page table 500 relating to a related page may refer to the main memory 200.

In step 6, an instruction that performed the page fault is performed again. Then a page related to the instruction is included in the main memory 200. Accordingly, a controller 100, i.e., a CPU may access needed data in the main memory 200.

When the page fault is generated as afore-mentioned, the data is loaded form the storage device 400 to the main memory 200. Herein, when a page size of the virtual memory 300 may not correspond with an input/output unit of the storage device 400, input/output of a plurality of storage device 400 may be performed.

Accordingly, an embodiment of the present description includes a page size of a virtual memory system of an operating system corresponding with a page size of an NAND flash memory or determined as a multiple of the size. Thus, prevents performance degradation that may be generated due to unit mismatch. Especially, performance degradation may prevented by accessing only the necessary data when performing page read/write of the NAND flash memory and the virtual memory.

The preferred embodiments of the invention have been explained so far. a person skilled in the art will understand that the invention may be performed in modifications without departing from the basic characteristics of the invention. Accordingly, the foregoing exemplary embodiments and advantages are merely exemplary and are not to be construed as limiting the present disclosure. The present teaching can be readily applied to other types of apparatuses. Also, the description of the exemplary embodiments of the present inventive concept is intended to be illustrative, and not to limit the scope of the claims.

What is claimed is:

1. A virtual memory system based on a storage device supporting massive input/output comprising:
a main memory;
a storage device configured to read/write data with a certain page unit;
a virtual memory that corresponds with the main memory and read/write data that is determined with a page unit size different from the storage device read and write data;
and,
a controller configured to recognize read/write unit of the storage device and the virtual memory and control the respective units to correspond with each other.

2. The virtual memory system based on a storage device supporting massive input/output of claim 1, wherein the controller is configured to correspond the data read/write unit of the virtual memory to a data unit of the storage device in real time or actively when booting the system, and the virtual memory read/write data based on a page unit of the storage device that corresponds by the controller.

3. The virtual memory system based on a storage device supporting massive input/output of claim 1, wherein the controller actively determines the data read/write unit of the virtual memory as a multiple of a page unit of the storage device when booting the system and, the virtual memory read/write a data based on a multiple of a page unit of the storage device that is determined by the controller.

4. The virtual memory system based on a storage device supporting massive input/output of claim 1, wherein the storage device may include a SWAP area.

5. The virtual memory system based on a storage device supporting massive input/output of claim 1, wherein the storage device may perform SWAP IN or SWAP OUT with an active page unit during data transfer between the main memory and the SWAP area.
